(19) United States
(12) Patent Application Publication
(10) Pub. No.: US 2017/0119196 A1
(43) Pub. Date: May 4, 2017

(54) Thermo tea maker

(71) Applicants: Hui-Ju Chen, Taipei (TW); Hsiu-Lan Chen Lu, Taichung (TW); Han Tsung Chen, Taichung (TW); Wei Fu Chen, Taichung (TW)

(72) Inventors: Hui-Ju Chen, Taipei (TW); Hsiu-Lan Chen Lu, Taichung (TW); Han Tsung Chen, Taichung (TW); Wei Fu Chen, Taichung (TW)

(21) Appl. No.: 15/407,269

(22) Filed: Jan. 17, 2017

(51) Int. Cl. A47J 31/06; A47J 31/00

(52) U.S. Cl. CPC A47J 31/06; A47J 31/0605; A47J 31/005

(57) ABSTRACT

A thermo tea maker includes a tea cup and a tea infuser. The exterior of the tea cup has a first isolation gap in a vacuum state to block the heat conduction from an inner part to an outer part of the cup part. The exterior of the tea infuser has a second isolation gap in a vacuum state to block the heat conduction from an inner segment to an outer segment of the tea infuser. The tea cup and the tea infuser are able to keep the tea warm. When the tea infuser is turned, the tea infuser will not scald the user's hand.

### FIELD OF THE INVENTION

The present invention relates to a tea maker, and more particularly to a thermo tea maker able to prevent a user from being scalded.

### BACKGROUND OF THE INVENTION

A conventional rotary tea maker includes a tea cup and a tea infuser. A bottom end of the tea cup is provided with a detachable bottom cover. An upper portion of the tea cup is provided with a partition therein to partition the tea cup into a tea room and a coupling trough. The partition is formed with a through hole for the tea room to communicate with the coupling trough. An inner wall of the coupling trough is formed with an inner threaded portion. A top end of the tea infuser is provided with a detachable upper cover. The tea infuser has a tea brewing room therein and a bottom portion at a lower end thereof. An outer wall of the bottom portion is formed with an outer threaded portion to mate with the inner threaded portion of the tea cup. The bottom portion is formed with a water outlet which is disposed to stagger the through hole of the tea cup. The bottom portion of the tea infuser is formed with an air pipe extending toward the tea brewing room to approach the upper cover. The air pipe and the through hole of the tea cup are staggered. The air pipe has an air hole therein, enabling the bottom portion to communicate with the tea brewing room. When the upper cover is opened and tea leaves are placed into the tea infuser, the tea leaves are brewed in the tea brewing room of the tea infuser because the water outlet of the tea infuser and the through hole of the tea cup are staggered and not in communication with each other. In order to prevent the tea leaves from infusing too long, the tea infuser can be turned anytime for the outer threaded portion to disengage from the inner threaded portion of the tea cup to form a passage between the bottom portion of the tea infuser and the partition of the tea cup, such that the water outlet is in communication with the through hole and the tea in the tea brewing room of the tea infuser flows from the water outlet through the passage and the through hole to enter the tea room of the tea cup. For next tea brewing, the tea infuser is turned reversely, enabling the outer threaded portion of the tea infuser to engage with the inner threaded portion of the tea cup. The passage between the water outlet and the through hole is closed, so that the water outlet is not in communication with the through hole. The user can invert the tea cup and open the bottom cover to drink the tea in the tea room.

The above-mentioned conventional tea maker uses the engagement and disengagement of the outer threaded portion of the tea infuser and the inner threaded portion of the tea cup to open or close the passage between the water outlet of the tea infuser and the through hole of the tea cup. According to different needs, the passage can be adjusted. Through rotation of the tea infuser, the tea is discharged from the tea brewing room to be stored in the tea room of the tea cup for use. However, during the process of brewing tea, the heat of the hot water poured in the tea brewing room is conducted to the wall of the tea infuser quickly. When the tea infuser is turned, the tea infuser may scald the user's hand. Besides, the temperature of the tea stored in the tea room of the tea cup can't be maintained for a long period of time. Accordingly, the inventor of the present invention has devoted himself based on his many years of practical experiences to solve these problems.

### SUMMARY OF THE INVENTION

The primary object of the present invention is to provide a thermo tea maker. The thermo tea maker comprises a tea cup and a tea infuser. A bottom end of the tea cup is provided with a detachable bottom cover. An upper portion of the tea cup is provided with a partition therein to partition the tea cup into a tea room and a coupling trough. The partition is eccentrically formed with a through hole for the tea room to communicate with the coupling trough. An inner wall of the coupling trough is formed with an inner threaded portion. A top end of the tea infuser is provided with a detachable upper cover. The tea infuser has a tea brewing room therein and a bottom portion at a lower end thereof. An outer wall of the bottom portion is formed with an outer threaded portion to mate with the inner threaded portion of the tea cup. The bottom portion is formed with a water outlet which is eccentrically disposed to stagger the through hole of the tea cup. The tea cup is composed of an inner part and an outer part. The inner part and the outer part are connected with each other in an airtight manner. A first isolation gap is formed between the inner part and the outer part. The interior of the partition is formed with a first space communicating with the first isolation gap. An air outlet is formed between the first space and the coupling trough. A first check valve is provided at one end of the air outlet. Through the control of the first check valve, the air is exhausted from the air outlet so that the first isolation gap and the first space are in a vacuum state for a long period of time. The tea infuser is composed of an inner segment and an outer segment. The inner segment and the outer segment are connected with each other in an airtight manner. A second isolation gap is formed between the inner segment and the outer segment. The interior of the bottom portion is formed with a second space communicating with the second isolation gap. A vent is formed between the second space and the coupling trough of the tea cup. A second check valve is provided at one end of the vent. Through the control of the second check valve, the air is exhausted from the vent so that the second isolation gap and the second space are in a vacuum state for a long period of time. When the upper cover is opened and tea leaves are placed into the tea infuser, the outer threaded portion of the tea infuser is tightly meshed with the inner threaded portion of the tea cup. The water outlet of the tea infuser is blocked by the partition of the tea cup and the through hole of the tea cup is blocked by the bottom portion of the tea infuser, such that the water outlet and the through hole are closed and not in communication with each other. The tea leaves are brewed in the tea brewing room of the tea infuser. In order to prevent the tea leaves from infusing too long, the tea infuser can be turned anytime for the outer threaded portion to disengage from the inner threaded portion of the tea cup to form a passage between the bottom portion of the tea infuser and the partition of the tea cup, such that the water outlet is in communication with the through hole and the tea in the tea brewing room of the tea infuser flows from the water outlet through the passage and the through hole to enter the tea room of the tea cup. For next tea brewing, the tea infuser is turned reversely, enabling the outer threaded portion of the tea infuser to engage with the inner threaded portion of the tea cup. The passage between the water outlet and the through hole is closed, so that the water outlet is not in communication with the through hole. The user can invert the tea cup and open the bottom cover to drink the tea in the tea room. The exterior of the tea cup has the first isolation gap in a vacuum state to block the heat conduction from the inner part to the outer part. The exterior of the tea infuser has the second isolation gap in a vacuum state to block the heat conduction from the inner segment to the outer segment. The tea cup and the tea infuser are able to keep the tea warm. When the tea infuser is turned, the tea infuser will not scald the user's hand.

Preferably, the outer wall of the bottom portion of the tea infuser is formed with a neck portion. The neck portion is provided with an annular engaging rib. The engaging rib is coupled with a soft rubber member. The soft rubber member has a rubber plate attached to the bottom surface of the bottom portion. The rubber plate has a perforation corresponding to the water outlet. When the outer threaded portion of the tea infuser and the inner threaded portion of the tea cup are locked tightly, the rubber plate of the soft rubber member is compressed between the bottom portion and the partition to improve the sealing for blocking the communication between the water outlet and the through hole. When the tea is brewed in the tea brewing room of the tea infuser, the tea won't flow to the tea room of the tea cup.

Preferably, the bottom portion of the tea infuser is formed with the water outlet. The tea infuser is provided with a filter screen disposed above the water outlet of the bottom portion. The filter screen is configured to filter the tea leaves when the tea in the tea brewing room of the tea infuser is discharged to the tea room of the tea cup through the passage.

Preferably, each of the bottom cover and the upper cover is composed of a main cover and an outer sleeve which are connected with each other in an airtight manner. An isolation chamber is formed between the inner cover and the outer sleeve. An exhaust hole is provided between the isolation chamber and the outside. An airtight check valve is provided at one end of the exhaust hole. Through the control of the airtight check valve, the air is exhausted from the exhaust hole so that the isolation chamber is in a vacuum state for a long period of time. When in use, this design helps the tea cup and the tea infuser keep the tea warm. The airtight check valve includes a valve seat and a valve plate. The valve seat is configured to seal the inner end of the exhaust hole and has a valve hole corresponding to the exhaust hole. The valve plate is disposed inside the valve seat for sealing the valve hole.

When the isolation chamber is exhausted from the exhaust hole, the valve plate is deformed to depart from the valve hole so that the air is exhausted. On the contrary, when the isolation chamber is not exhausted from the exhaust hole, the isolation chamber forms negative pressure and the valve plate is returned to seal the valve hole so that the outside air can be easily blocked from entering the isolation chamber. A plug is provided to seal the exhaust hole so that the isolation chamber can be maintained in a vacuum state for a long period of time.

Preferably, each of the first check valve on the partition of the tea cup and the second check valve on the bottom portion of the tea infuser includes a valve seat and a valve plate. The valve seats of the first check valve and the second check valve are configured to seal the inner ends of the air outlet and the vent respectively, and have valve holes corresponding to the air outlet and the vent respectively. The valve plate is disposed inside the valve seat for sealing the valve hole. When the first space and the second space are exhausted from the air outlet and the vent respectively, the valve plate is deformed to depart from the valve hole so that the air is exhausted. On the contrary, when the first space and the second space are not exhausted from the air outlet and the vent respectively, the first space and the second space form negative pressure, and the valve plate is returned to seal the valve hole so that the outside air can be easily blocked from entering the first space and the second space. A plug is provided to seal the air outlet and the vent respectively so that the insides of the tea cup and the tea infuser can be maintained in a vacuum state for a long period of time.

Preferably, the outer periphery of the inner threaded portion of the tea cup is formed with at least one lower stop portion protruding outward. The upper periphery of the outer threaded portion of the tea infuser is formed with at least one upper stop portion protruding outward. A restraining ring is provided between the lower stop portion and the upper stop portion. The upper and lower inner edges of the restraining ring are formed with at least one upper buckle portion and at least one lower buckle portion to buckle the upper stop portion and the lower stop portion respectively. When the outer threaded portion of the tea infuser is turned reversely to unscrew from the inner threaded portion of the tea cup, because the upper and lower buckle portions of the restraining ring are buckled against the upper and lower stop portions, the outer threaded portion won't completely disengage from the inner threaded portion. When the tea infuser is rotated relative to the tea cup, the tea infuser won't disengage from the tea cup.

### BRIEF DESCRIPTION OF THE DRAWINGS

FIG. 1 is an exploded view in accordance with a preferred embodiment of the present invention;

FIG. 2 is a sectional view in accordance with the preferred embodiment of the present invention;

FIG. 3 is an enlarged view of a circle A of FIG. 2;

FIG. 4 is an exploded view of the first check valve in accordance with the preferred embodiment of the present invention;

FIG. 5 is a schematic view in accordance with the preferred embodiment of the present invention, showing that the tea leaves are brewed;

FIG. 6 is a schematic view in accordance with the preferred embodiment of the present invention, showing that the tea flows from the tea infuser to the tea cup;

FIG. 7 is a schematic view in accordance with the preferred embodiment of the present invention, showing that the passage is closed to prevent the tea from flowing back to the tea infuser; and

FIG. 8 is an exploded view of the bottom cover in accordance with the preferred embodiment of the present invention.

### DETAILED DESCRIPTION OF THE PREFERRED EMBODIMENTS

Embodiments of the present invention will now be described, by way of example only, with reference to the accompanying drawings.

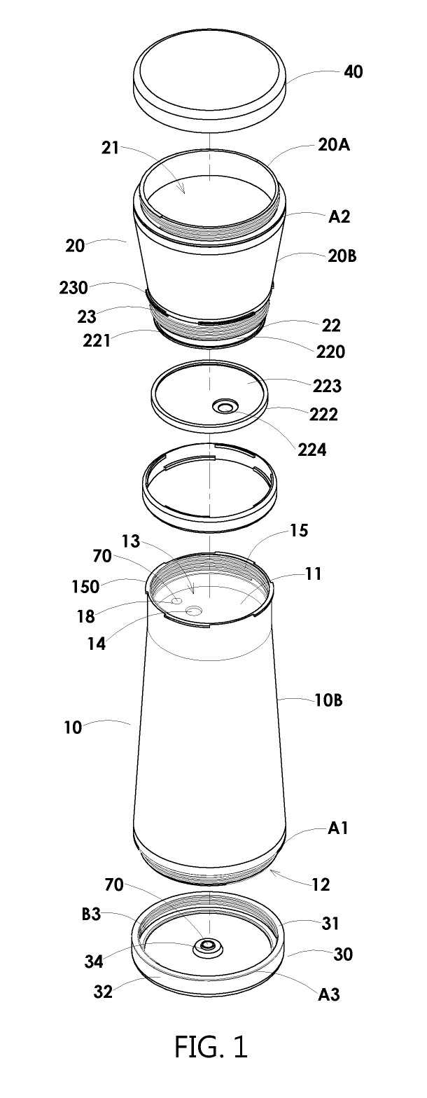

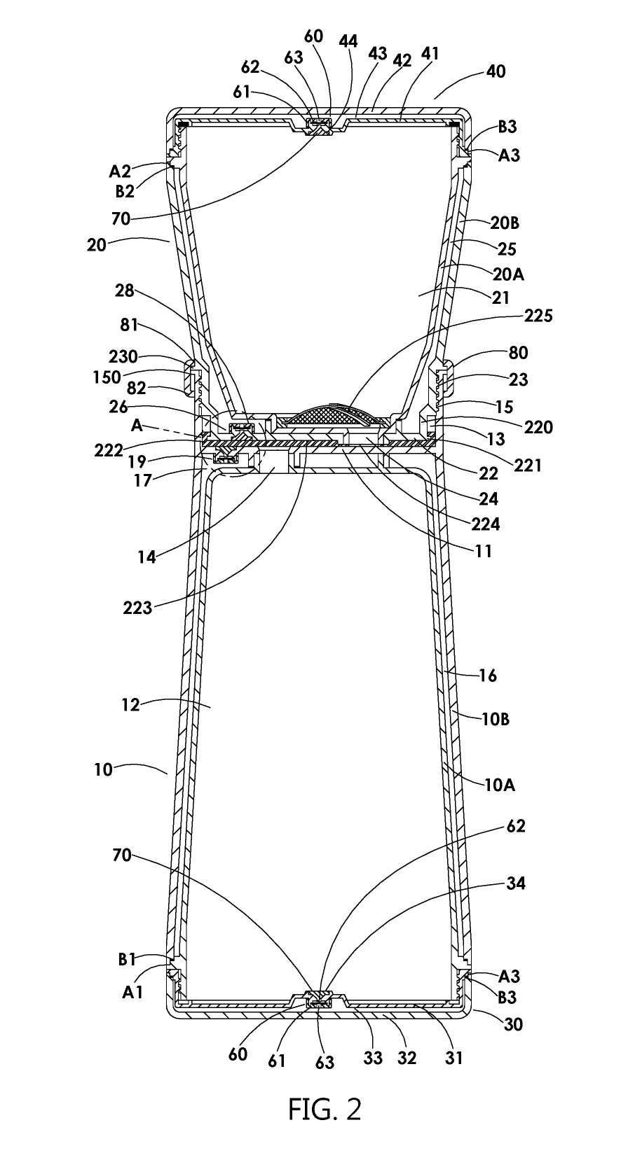

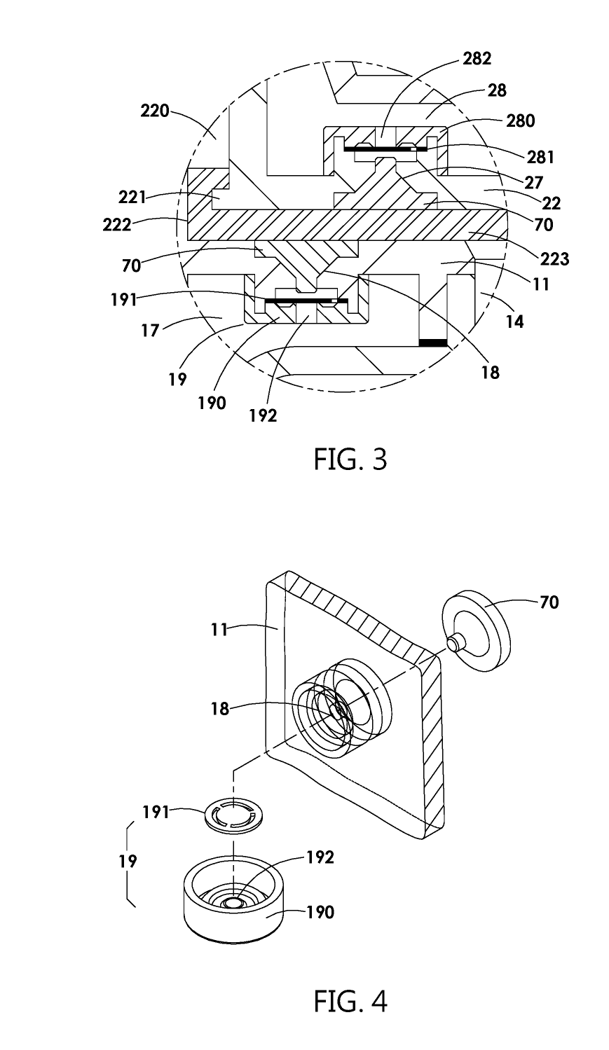

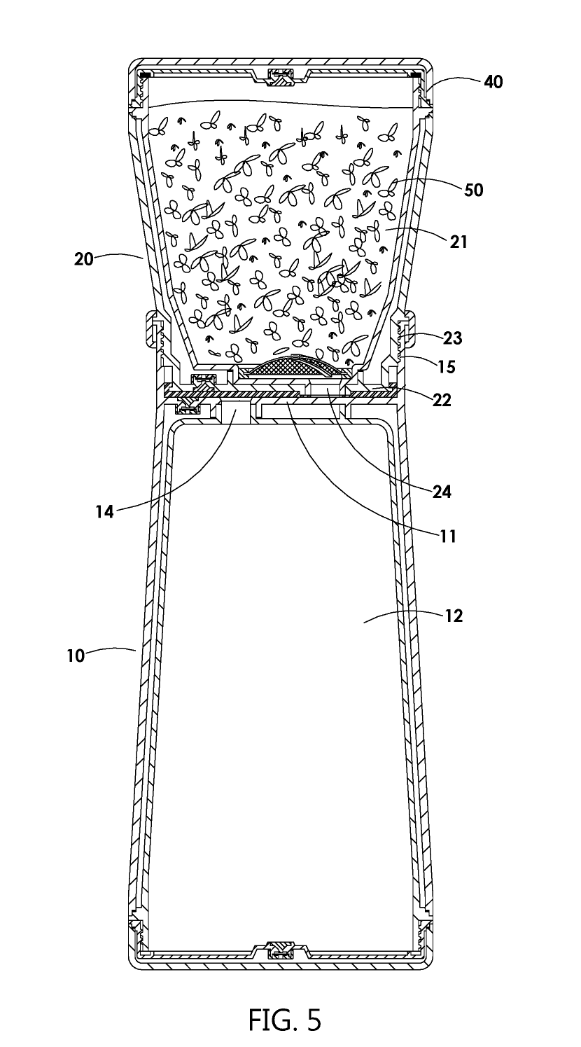

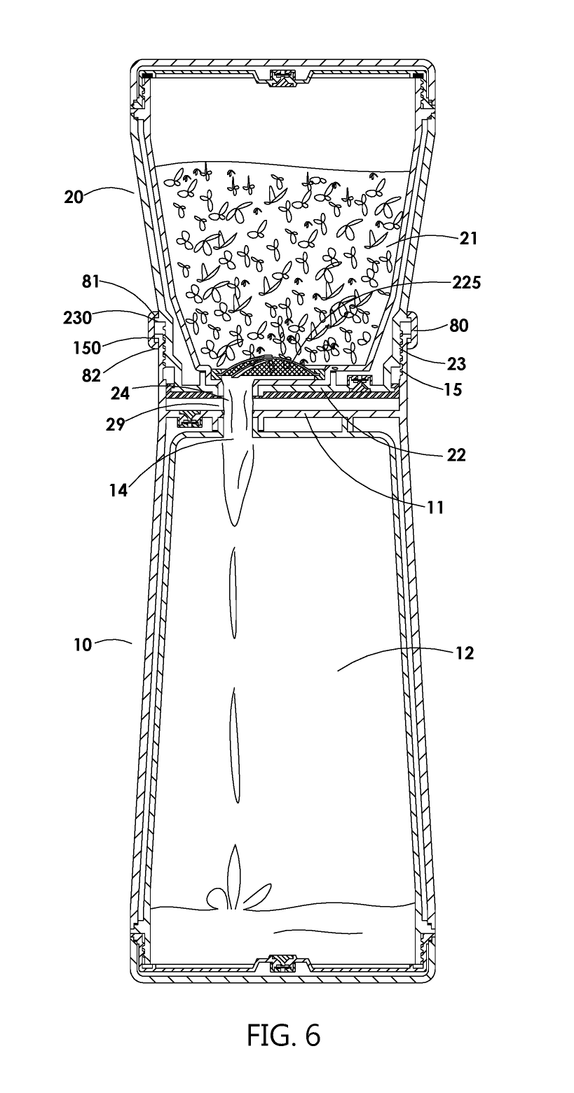

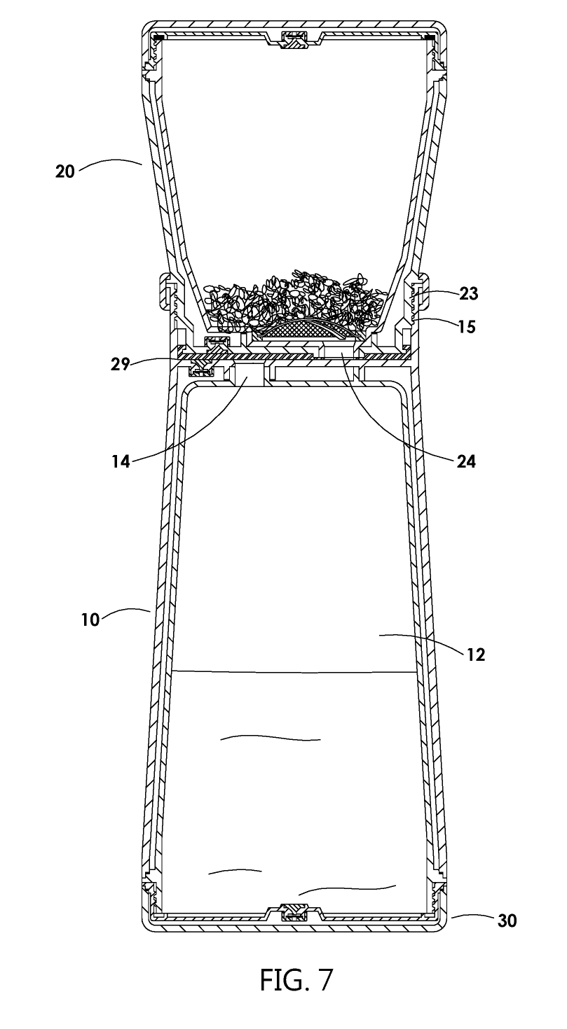

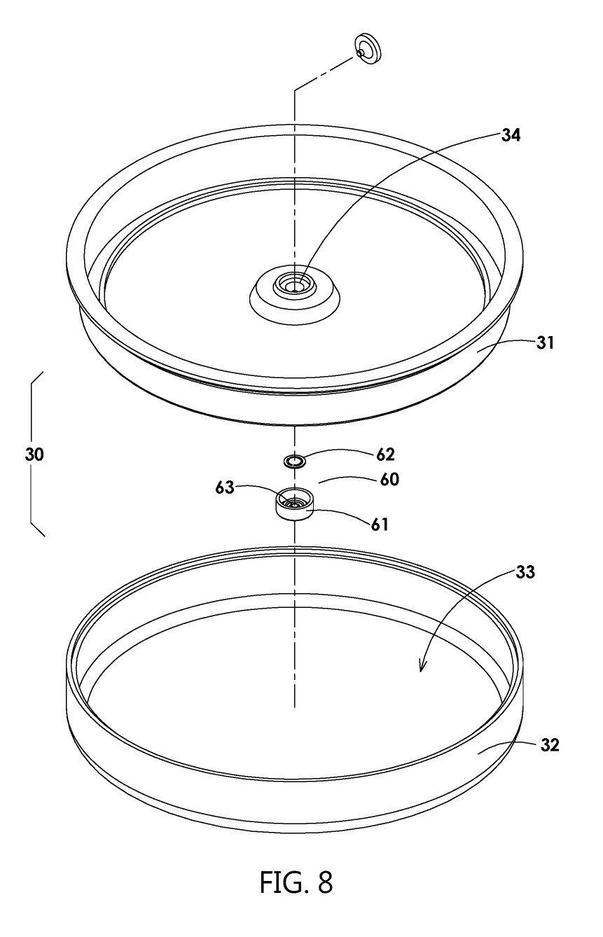

As shown in FIG. 1, FIG. 2, FIG. 3 and FIG. 4, the present invention discloses a thermo tea maker. The thermo tea maker comprises a tea cup 10 and a tea infuser 20. A bottom end of the tea cup 10 is provided with a detachable bottom cover 30. An upper portion of the tea cup 10 is provided with a partition 11 therein to partition the tea cup 10 into a tea room 12 and a coupling trough 13. The partition 11 is eccentrically formed with a through hole 14 for the tea room 12 to communicate with the coupling trough 13. An inner wall of the coupling trough 13 is formed with an inner threaded portion 15. A top end of the tea infuser 20 is provided with a detachable upper cover 40. The tea infuser 20 has a tea brewing room 21 therein and a bottom portion 22 at a lower end thereof. An outer wall of the bottom portion 22 is formed with an outer threaded portion 23 to mate with the inner threaded portion 15 of the tea cup 10. The bottom portion 22 is further formed with a water outlet 24 which is eccentrically disposed to stagger the through hole 14 of the tea cup 10. The tea cup 10 is composed of an inner part 10A and an outer part 10B. The inner part 10A and the outer part 10B are connected with each other in an airtight manner (by an ultrasonic welding A1 in cooperation with a soft gasket B1). A first isolation gap 16 is formed between the inner part 10A and the outer part 10B. The interior of the partition 11 is formed with a first space 17 communicating with the first isolation gap 16. An air outlet 18 is formed between the first space 17 and the coupling trough 13. A first check valve 19 is provided at one end (inner end) of the air outlet 18. Through the control of the first check valve 19, the air is exhausted from an outer end of the air outlet 18 so that the first isolation gap 16 and the first space 17 are in a vacuum state for a long period of time. The tea infuser 20 is composed of an inner segment 20A and an outer segment 20B. The inner segment 20A and the outer segment 20B are connected with each other in an airtight manner (by an ultrasonic welding A2 in cooperation with a soft gasket B2). A second isolation gap 25 is formed between the inner segment 20A and the outer segment 20B. The interior of the bottom portion 22 is formed with a second space 26 communicating with the second isolation gap 25. A vent 27 is formed between the second space 26 and the coupling trough 13 of the tea cup 10. A second check valve 28 is provided at one end (inner end) of the vent 27. Through the control of the second check valve 28, the air is exhausted from an outer end of the vent 27 so that the second isolation gap 25 and the second space 26 are in a vacuum state for a long period of time. As shown in FIG. 5, when the upper cover 40 is opened and tea leaves 50 are placed into the tea infuser 20. Hot water is poured into the tea infuser 20, and then the upper cover 40 is to cover the tea infuser 20 again. The outer threaded portion 23 of the tea infuser 20 is tightly meshed with the inner threaded portion 15 of the tea cup 10. The water outlet 24 of the tea infuser 20 is blocked by the partition 11 of the tea cup 10 and the through hole 14 of the tea cup 10 is blocked by the bottom portion 22 of the tea infuser 20, such that the water outlet 24 and the through hole 14 are closed and not in communication with each other. The tea leaves 50 are brewed in the tea brewing room 21 of the tea infuser 20. In order to prevent the tea leaves 50 from infusing too long, the tea infuser 20 can be turned anytime for the outer threaded portion 23 to disengage from the inner threaded portion 15 of the tea cup 10, as shown in FIG. 6, to form a passage 29 between the bottom portion 22 of the tea infuser 20 and the partition 11 of the tea cup 10, such that the water outlet 24 is in communication with the through hole 14 and the tea in the tea brewing room 21 of the tea infuser 20 flows from the water outlet 24 through the passage 29 and the through hole 14 to enter the tea room 12 of the tea cup 10. For next tea brewing, as shown in FIG. 7, the tea infuser 20 is turned reversely, enabling the outer threaded portion 23 of the tea infuser 20 to engage with the inner threaded portion 15 of the tea cup 10. The passage 29 between the water outlet 24 and the through hole 14 is closed, so that the water outlet 24 is not in communication with the through hole 14. The user can invert the tea cup 10 and open the bottom cover 30 to drink the tea in the tea room 12. The exterior of the tea cup 10 has the first isolation gap 16 in a vacuum state to block the heat conduction from the inner part 10A to the outer part 10B. The exterior of the tea infuser 20 has the second isolation gap 25 in a vacuum state to block the heat conduction from the inner segment 20A to the outer segment 20B. As shown in FIG. 5 and FIG. 7, the tea cup 10 and the tea infuser 20 are able to keep the tea warm. As shown in FIG. 6, when the tea infuser 20 is turned, the tea infuser 20 will not scald the user's hand.

According to the aforesaid embodiment, as shown in FIG. 1 and FIG. 2, the outer wall of the bottom portion 22 of the tea infuser 20 is further formed with a neck portion 220. The neck portion 220 is provided with an annular engaging rib 221. The engaging rib 221 is coupled with a soft rubber member 222. The soft rubber member 222 has a rubber plate 223 attached to the bottom surface of the bottom portion 22. The rubber plate 223 has a perforation 224 corresponding to the water outlet 24. When the outer threaded portion 23 of the tea infuser 20 and the inner threaded portion 15 of the tea cup 10 are locked tightly, the rubber plate 223 of the soft rubber member 222 is compressed between the bottom portion 22 and the partition 11 to improve the sealing for blocking the communication between the water outlet 24 and the through hole 14. When the tea is brewed in the tea brewing room 21 of the tea infuser 20, the tea won't flow to the tea room 12 of the tea cup 10.

According to the aforesaid embodiment, as shown in FIG. 2, the bottom portion 22 of the tea infuser 20 is formed with the water outlet 24. The tea infuser 20 is further provided with a filter screen 225 disposed above the water outlet 24 of the bottom portion 22. As shown in FIG. 6, the filter screen 225 is configured to filter the tea leaves 50 when the tea in the tea brewing room 21 of the tea infuser 20 is discharged to the tea room 12 of the tea cup 10 through the passage 29.

According to the forgoing embodiment, as shown in FIGS. 1, 2, and 8, the bottom cover 30 and the upper cover 40 have the same structure. FIG. 8 is an exploded view of the bottom cover 30 as an example. The bottom cover 30 is composed of a main cover 31 and an outer sleeve 32 which are connected with each other in an airtight manner (by an ultrasonic welding A3 in cooperation with a soft gasket B3). An isolation chamber 33 is formed between the inner cover 31 and the outer sleeve 32. An exhaust hole 34 is provided between the isolation chamber 33 and the outside. The upper cover 40 is composed of a main cover 41 and an outer sleeve 42 which are connected with each other in an airtight manner (by an ultrasonic welding A3 in cooperation with a soft gasket B3). An isolation chamber 43 is formed between the inner cover 41 and the outer sleeve 42. An exhaust hole 44 is provided between the isolation chamber 43 and the outside. An airtight check valve 60 is provided at one end (inner end) of the exhaust hole 34, 44. Through the control of the airtight check valve 60, the air is exhausted from an outer end of the exhaust hole 34, 44 so that the isolation chamber 33, 43 is in a vacuum state for a long period of time. As shown in FIG. 5 and FIG. 7, when in use, this design helps the tea cup 10 and the tea infuser 20 keep the tea warm. As shown in FIG. 2, the airtight check valve 60 includes a valve seat 61 and a valve plate 62. The valve seat 61 is configured to seal the inner end of the exhaust hole 34, 44, and has a valve hole 63 corresponding to the exhaust hole 34, 44. The valve plate 62 is disposed inside the valve seat 61 for sealing the valve hole 63. When the isolation chamber 33, 43 is exhausted from the exhaust hole 34, 44, the valve plate 62 is deformed (not shown) to depart from the valve hole 63 so that the air is exhausted. On the contrary, when the isolation chamber 33, 43 is not exhausted from the exhaust hole 34, 44, the isolation chamber 33, 43 forms negative pressure, and the valve plate 62 is returned to seal the valve hole 63 so that the outside air can be easily blocked from entering the isolation chamber 33, 43. A plug 70 is provided to seal the exhaust hole 34, 44 so that the isolation chamber 33, 43 can be maintained in a vacuum state for a long period of time.

According to the forgoing embodiment, as shown in FIGS. 1-4, the first check valve 19 on the partition 11 of the tea cup 10 and the second check valve 28 on the bottom portion 22 of the tea infuser 20 have the same structure. FIG. 4 is an exploded view of the first check valve 19 as an example. The first check valve 19 includes a valve seat 190 and a valve plate 191. The second check valve 28 includes a valve seat 280 and a valve plate 281. The valve seats 190, 280 of the first check valve 19 and the second check valve 28 are configured to seal the inner ends of the air outlet 18 and the vent 27 respectively, and have valve holes 192, 282 corresponding to the air outlet 18 and the vent 27 respectively. The valve plate 191 is disposed inside the valve seat 190 for sealing the valve hole 192. The valve plate 281 is disposed inside the valve seat 280 for sealing the valve hole 282. When the first space 17 and the second space 26 are exhausted from the air outlet 18 and the vent 27 respectively, the valve plates 191, 281 are deformed (not shown) to depart from the valve holes 192, 282 so that the air is exhausted. On the contrary, when the first space 17 and the second space 26 are not exhausted from the air outlet 18 and the vent 27 respectively, the first space 17 and the second space 26 form negative pressure, and the valve plates 191, 282 are returned to seal the valve holes 191, 282 so that the outside air can be easily blocked from entering the first space 17 and the second space 26. A plug 70 is provided to seal the air outlet 18 and the vent 27 respectively so that the insides of the tea cup 10 and the tea infuser 20 can be maintained in a vacuum state for a long period of time.

According to the forgoing embodiment, as shown in FIG. 1 and FIG. 2, the outer periphery of the inner threaded portion 15 of the tea cup 10 is formed with at least one lower stop portion 150 protruding outward. The upper periphery of the outer threaded portion 23 of the tea infuser 20 is formed with at least one upper stop portion 230 protruding outward. A restraining ring 80 is provided between the lower stop portion 150 and the upper stop portion 230. The upper and lower inner edges of the restraining ring 80 are formed with at least one upper buckle portion 81 and at least one lower buckle portion 82 to buckle the upper stop portion 230 and the lower stop portion 150 respectively. As shown in FIG. 6, when the outer threaded portion 23 of the tea infuser 20 is turned reversely to unscrew from the inner threaded portion 15 of the tea cup 10, because the upper and lower buckle portions 81, 82 of the restraining ring 80 are buckled against the upper and lower stop portions 230, 150, the outer threaded portion 23 won't completely disengage from the inner threaded portion 15. When the tea infuser 20 is rotated relative to the tea cup 10, the tea infuser 20 won't disengage from the tea cup 10.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A thermo tea maker, comprising a tea cup and a tea infuser; a bottom end of the tea cup being provided with a detachable bottom cover, an upper portion of the tea cup being provided with a partition therein to partition the tea cup into a tea room and a coupling trough, the partition being eccentrically formed with a through hole for the tea room to communicate with the coupling trough, an inner wall of the coupling trough being formed with an inner threaded portion; a top end of the tea infuser being provided with a detachable upper cover, the tea infuser having a tea brewing room therein and a bottom portion at a lower end thereof, an outer wall of the bottom portion being formed with an outer threaded portion to mate with the inner threaded portion of the tea cup, the bottom portion being formed with a water outlet which is eccentrically disposed to stagger the through hole of the tea cup; characterized in that: the tea cup is composed of an inner part and an outer part, the inner part and the outer part are connected with each other in an airtight manner, a first isolation gap is formed between the inner part and the outer part, an interior of the partition is formed with a first space communicating with the first isolation gap, an air outlet is formed between the first space and the coupling trough, a first check valve is provided at one end of the air outlet, through control of the first check valve, air is exhausted from the air outlet so that the first isolation gap and the first space are in a vacuum state for a long period of time; the tea infuser is composed of an inner segment and an outer segment, the inner segment and the outer segment are connected with each other in an airtight manner; a second isolation gap is formed between the inner segment and the outer segment, an interior of the bottom portion is formed with a second space communicating with the second isolation gap, a vent is formed between the second space and the coupling trough of the tea cup, a second check valve is provided at one end of the vent, through control of the second check valve, and air is exhausted from the vent so that the second isolation gap and the second space are in a vacuum state for a long period of time.

2. The thermo tea maker as claimed in claim 1, wherein the outer wall of the bottom portion of the tea infuser is formed with a neck portion, the neck portion is provided with an annular engaging rib, the engaging rib is coupled with a soft rubber member, the soft rubber member has a rubber plate attached to a bottom surface of the bottom portion, and the rubber plate has a perforation corresponding to the water outlet.

3. The thermo tea maker as claimed in claim 1, wherein the tea infuser is provided with a filter screen disposed above the water outlet of the bottom portion.

4. The thermo tea maker as claimed in claim 1, wherein each of the bottom cover and the upper cover is composed of a main cover and an outer sleeve which are connected with each other in an airtight manner, an isolation chamber is formed between the inner cover and the outer sleeve, an exhaust hole is provided between the isolation chamber and the outside, and an airtight check valve is provided at one end of the exhaust hole.

5. The thermo tea maker as claimed in claim 4, wherein the airtight check valve includes a valve seat and a valve plate, the valve seat is configured to seal an inner end of the exhaust hole and has a valve hole corresponding to the exhaust hole, and the valve plate is disposed inside the valve seat for sealing the valve hole.

6. The thermo tea maker as claimed in claim 1, wherein each of the first check valve on the partition of the tea cup and the second check valve on the bottom portion of the tea infuser includes a valve seat and a valve plate, the valve seats of the first check valve and the second check valve are configured to seal inner ends of the air outlet and the vent respectively and have valve holes corresponding to the air outlet and the vent respectively, and the valve plate is disposed inside the valve seat for sealing the valve holes.

7. The thermo tea maker as claimed in claim 1, wherein an outer periphery of the inner threaded portion of the tea cup is formed with at least one lower stop portion protruding outward, an upper periphery of the outer threaded portion of the tea infuser is formed with at least one upper stop portion protruding outward, a restraining ring is provided between the lower stop portion and the upper stop portion, and upper and lower inner edges of the restraining ring are formed with at least one upper buckle portion and at least one lower buckle portion to buckle the upper stop portion and the lower stop portion respectively.
